(19) United States
(12) Patent Application Publication
(10) Pub. No.: US 2026/0072446 A1
(43) Pub. Date: Mar. 12, 2026

(54) UNMANNED AERIAL VEHICLE AND METHOD FOR BRIDGE INSPECTION

(71) Applicant: DELTA ELECTRONICS, INC., Taoyuan City (TW)

(72) Inventors: Tzu-Yang LIN, Taoyuan City (TW); Kual-Zheng LEE, Taoyuan City (TW); Yung-Cheng KAO, Taoyuan City (TW)

(21) Appl. No.: 18/811,950

(22) Filed: Aug. 22, 2024

(30) Foreign Application Priority Data
Aug. 29, 2023 (TW) 112132606

(51) Int. Cl. G05D 1/648; B64U 10/14; B64U 20/87; B64U 101/26; G05D 1/646; G05D 105/80; G05D 109/20; G05D 111/10; G06V 20/10; G06V 20/17; G08G 5/57

(52) U.S. Cl. CPC G05D 1/648; B64U 10/14; B64U 20/87; G05D 1/646; G06V 20/17; G06V 20/176; G08G 5/57; B64U 2101/26; B64U 2201/10; G05D 2105/89; G05D 2109/20; G05D 2111/17

(57) ABSTRACT

An unmanned aerial vehicle and method for bridge inspection are provided. The unmanned aerial vehicle identifies a calibration line in an image corresponding to a target bridge. The unmanned aerial vehicle controls the unmanned aerial vehicle to fly along the calibration line to execute a bridge inspection task based on the image including an obscured part and an unobstructed part, and a calibration starting point and a calibration ending point of the calibration line are respectively corresponding to a longitude and latitude coordinate in a real world.

### CROSS-REFERENCE TO RELATED APPLICATION

This application claims priority to Taiwan Application Serial Number 112132606, filed Aug. 29, 2023, which is herein incorporated by reference in its entirety.

### BACKGROUND

### Field of Invention

The present invention relates to an unmanned aerial vehicle and method for bridge inspection. More particularly, the present invention relates to an unmanned aerial vehicle and method capable of performing the task of inspecting bridges.

### Description of Related Art

Recently, with the rapid development of Unmanned Aerial Vehicle (UAV) technology, a large number of applications related to UAV have been proposed one after another. In addition, due to the cost and speed advantages of the unmanned aerial vehicle, the task of inspecting objects through unmanned aerial vehicles (e.g., the safety inspection of the bridge structure) is one of the most important applications.

In the prior art, when the unmanned aerial vehicle is operating, it needs to hover stably in the air according to its coordinates (e.g., Global Positioning System (GPS)), height (e.g., Barometer), and head direction (e.g., Magnetometer). However, when the GPS signal is blocked by buildings (e.g., under a bridge) or the weather is poor, the unmanned aerial vehicle may cause flight safety issues.

In the prior art, there are many auxiliary positioning methods for weak GPS environments, such as visual navigation methods (e.g., Visual Localization and Mapping) through computer vision, lidar, etc.

However, since the virtual map generated by visual navigation is based on the position of the unmanned aerial vehicle itself, it cannot mark the data position (i.e., world coordinate position) during inspection in real time and accurately, and therefore cannot be used when inspecting bridges.

Accordingly, there is an urgent need for technology that can perform the task of inspecting bridges.

### SUMMARY

An objective of the present disclosure is to provide an unmanned aerial vehicle for bridge inspection. The unmanned aerial vehicle comprises an upward camera device and a processor. The processor is electrically connected to the upward camera device. The upward camera device is configured to capture an image corresponding to a target bridge based on an upward shooting angle, and the image comprises an obscured part and an unobstructed part corresponding to a global positioning system. The processor identifies a calibration line corresponding to the target bridge in the image. The processor controls the unmanned aerial vehicle to fly along the calibration line based on the image comprising the obscured part and the unobstructed part to perform a bridge inspection task, and a calibration starting point and a calibration ending point of the calibration line each correspond to a latitude and longitude coordinate of a real world.

Another objective of the present disclosure is to provide an unmanned aerial vehicle for bridge inspection. The unmanned aerial vehicle comprises an upward camera device and a processor. The processor is electrically connected to the upward camera device. The upward camera device is configured to capture an image corresponding to a target bridge based on an upward shooting angle, and the image comprises a bridge bottom part and a sky part corresponding to the target bridge. The processor identifies a calibration line corresponding to the target bridge in the image. The processor controls the unmanned aerial vehicle to fly along the calibration line based on the image comprising the bridge bottom part and the sky part to perform a bridge inspection task, wherein a calibration starting point and a calibration ending point of the calibration line each correspond to a latitude and longitude coordinate of a real world.

Another objective of the present disclosure is to provide a bridge inspection method, which is adapted for use in an unmanned aerial vehicle. The unmanned aerial vehicle comprises an upward camera device and a processor, the upward camera device is configured to capture an image corresponding to a target bridge based on an upward shooting angle. The bridge inspection method comprises the following steps: identifying a calibration line corresponding to the target bridge in the image; and controlling the unmanned aerial vehicle to fly along the calibration line based on the image to perform a bridge inspection task, wherein a calibration starting point and a calibration ending point of the calibration line each correspond to a latitude and longitude coordinate of a real world.

According to the above descriptions, the bridge inspection technology (at least including the apparatus and the method) provided by the present disclosure constructs a virtual map by identifying the calibration line of the target bridge with known position information and the actual flight path of the unmanned aerial vehicle. Then, the bridge inspection technology provided by the present disclosure calculates the coordinate transformation matrix corresponding to the virtual map and the real world based on the actual flight path and the calibration line. In addition, the bridge inspection technology provided by the present disclosure can further control the unmanned aerial vehicle to fly along, based on a plurality of virtual inspection paths and the virtual map, the virtual inspection paths to detect the target bridge, and generate a plurality of inspection images corresponding to the target bridge and the real coordinate value of the real world corresponding to each of the inspection images. Due to the bridge inspection technology provided by the present disclosure, the task of inspecting bridges can be automatically and efficiently performed, thereby solving the shortcomings of the conventional technology.

The detailed technology and preferred embodiments implemented for the subject disclosure are described in the following paragraphs accompanying the appended drawings for people skilled in this field to well appreciate the features of the claimed disclosure.

### BRIEF DESCRIPTION OF THE DRAWINGS

FIG. 1 is a schematic diagram depicting the structure and environment of the unmanned aerial vehicle according to the first embodiment;

FIG. 2 is a schematic diagram depicting the inspection operation and the image of the first embodiment;

FIG. 3 is a schematic diagram depicting the output of some embodiments;

FIG. 4 is a schematic diagram depicting the relationships of some embodiments;

FIG. 5 is a schematic diagram depicting the flight results of some embodiments;

FIG. 6 is a partial flowchart depicting the bridge inspection method of the third embodiment; and

FIG. 7 is a schematic diagram depicting the flowchart of some embodiments.

### DETAILED DESCRIPTION

In the following description, an unmanned aerial vehicle and method for bridge inspection according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

First, in the application environment of the present disclosure, the purpose is to inspect the target bridge by an unmanned aerial vehicle equipped with cameras (single or plural). The present disclosure may use the unmanned aerial vehicle 1 to perform inspection operations corresponding to the target bridge.

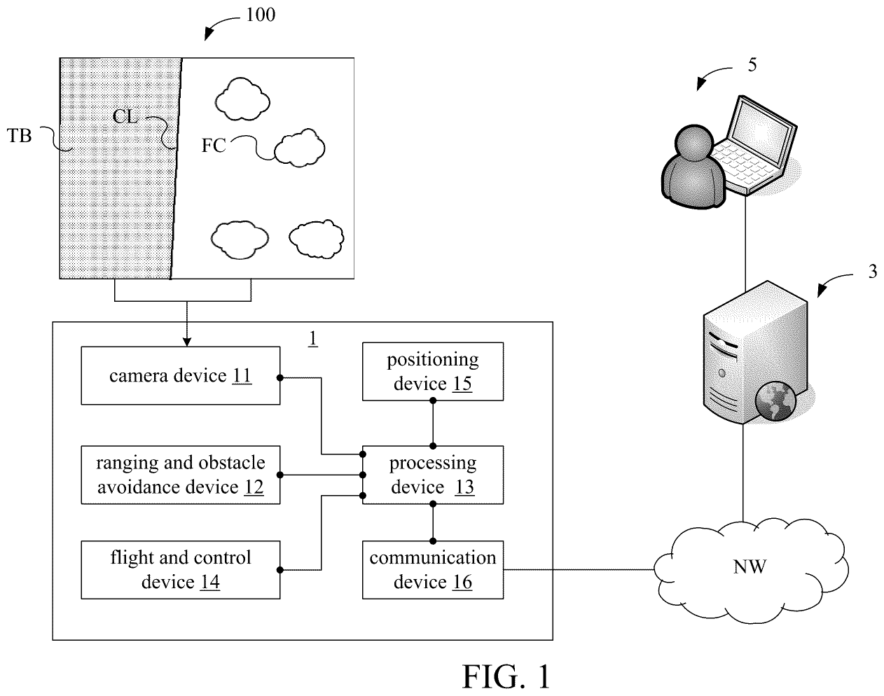

The first embodiment of the present disclosure is an unmanned aerial vehicle 1, and a schematic diagram is depicted in FIG. 1. The unmanned aerial vehicle 1 comprises a camera device 11, a ranging and obstacle avoidance device 12, a processing device 13, a flight and control device 14, a positioning device 15, and a communication device 16.

In some embodiments, the camera device 11 comprises an upward camera device. In some embodiments, the camera device 11 further comprises a camera device for inspection and a rotating component (e.g., gimbal). The ranging and obstacle avoidance device 12 comprises one or more ranging devices, such as an optical flow sensor, an optical radar (e.g., Light Detection And Ranging; LiDAR), an infrared ranging device, an ultrasonic ranging device, etc.

In some embodiments, the flight and control device 14 comprises a power device (e.g., a rotor or a fixed wing), an inertial measurement device (e.g., an accelerometer and a gyroscope), and an environment sensing device (e.g., a barometer, thermometer, magnetometer, etc.). The positioning device 15 comprises a GPS device. The communication device 16 comprises an antenna device.

In some embodiments, the processing device 13 comprises a processor, and the processing device 13 is electrically connected to the camera device 11 (e.g., the processor is electrically connected to the upward camera device). The processor may be any of various processors, Central Processing Units (CPUs), microprocessors, digital signal processors or other computing apparatuses known to those of ordinary skill in the art.

It shall be appreciated that the upward camera device is a camera device that can move the camera lens toward the top of the unmanned aerial vehicle 1 to take pictures, and therefore comprises but is not limited to a fixed upward camera device. Therefore, any camera device that can capture images from above should fall within the scope of the present disclosure, such as a camera device with a rotating mechanism (e.g., a gimbal) installed on the nose or tail of the unmanned aerial vehicle.

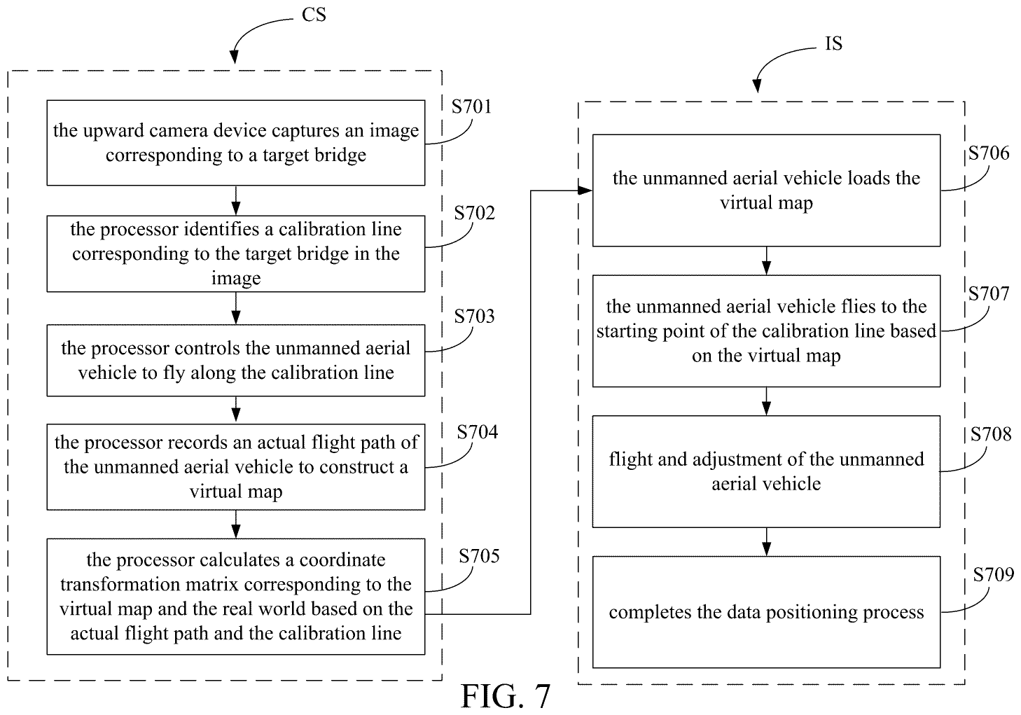

In some embodiments, in the operation application of the present disclosure, the unmanned aerial vehicle 1 can transmit the relevant image content generated by the unmanned aerial vehicle 1 to the computer 3 or related computing equipment on the ground through the network NW for processing. In some embodiments, the unmanned aerial vehicle 1 can receive a bridge inspection instruction from the user operating device 5, for example, perform a bridge inspection task between the 13th pier and the 14th pier of the bridge numbered A3. In the present embodiment, the upward camera device is configured to capture an image corresponding to a target bridge (e.g., operation S701 in FIG. 7) based on an upward shooting angle (e.g., an angle of 70 degrees upward from the horizontal plane). In some other embodiments, the unmanned aerial vehicle 1 uses a rotating mechanism to rotate the camera device to capture an image corresponding to a target bridge at an upward shooting angle.

In some embodiments, the image comprises a bridge bottom part and a sky part corresponding to the target bridge.

For ease of understanding, please refer to FIG. 1, which illustrates an image schematic diagram 100 captured by an upward camera device. In the present disclosure, when the upward camera device of the unmanned aerial vehicle 1 performs upward-looking shooting, an image as shown in FIG. 1 can be obtained, which comprises the target object (i.e., the target bridge TB) and the calibration line CL formed by it and the surrounding area. For example, the surrounding area may be the sky containing floating clouds FC, or other areas with a large color difference from the target object.

It shall be appreciated that the operation disclosed in the present disclosure can be divided into a calibration stage and an inspection stage (e.g., the calibration stage CS and the inspection stage IS in FIG. 7). First, in the calibration stage CS, the unmanned aerial vehicle 1 first flies a line segment with known length and path information (i.e., calibration line), calculates a transformation matrix between the virtual coordinate system (i.e., map-building coordinate system) and the real world coordinate system (i.e., world coordinate system) by analyzing the features of the calibration line in the image, and output the virtual map as the base map for the inspection stage IS. Next, during the inspection stage IS, the inspection stage IS uses the basic map for flight navigation and outputs the world coordinate values of the captured images.

The following will first describe the specific operation of the unmanned aerial vehicle 1 in the calibration stage CS in the present disclosure.

In the present embodiment, the processor identifies a calibration line corresponding to the target bridge in the image (e.g., operation S702 in FIG. 7). Next, the processor controls the unmanned aerial vehicle 1 to fly along the calibration line based on the image comprising a bridge bottom part and a sky part to perform a bridge inspection task (e.g., operation S703 in FIG. 7). In some embodiments, a calibration starting point and a calibration ending point of the calibration line each correspond to a latitude and longitude coordinate of a real world.

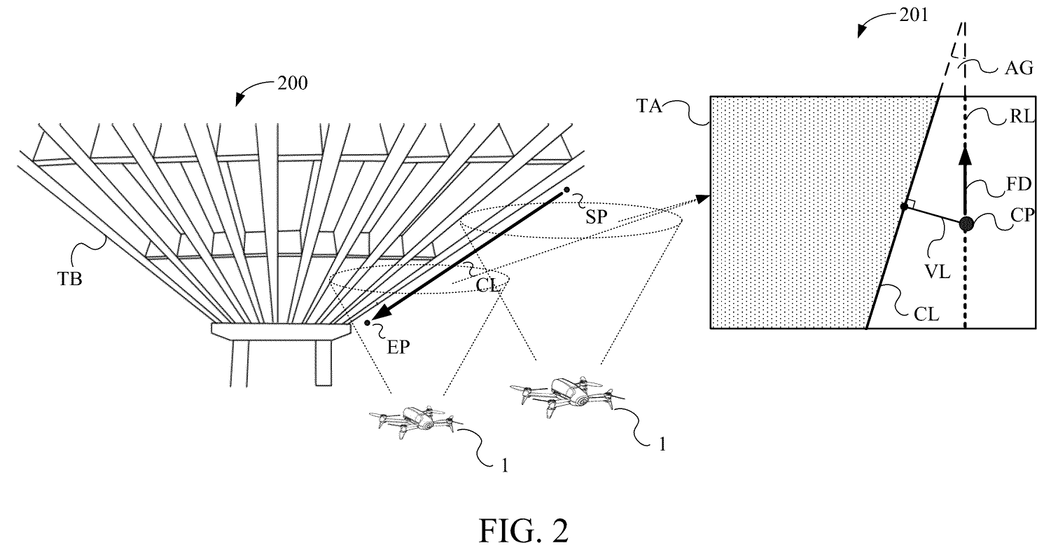

For ease of understanding, please refer to FIG. 2, which illustrates an inspection operation schematic diagram 200. In the inspection operation schematic diagram 200, an inspection target (i.e., the target bridge TB) has been pre-selected, and the unmanned aerial vehicle 1 is deployed near the target. The unmanned aerial vehicle 1 can be controlled through, for example, a remote controller, computer, mobile phone, or smart terminal.

In the present example, a straight line area of known length is pre-selected on the target bridge TB as the calibration line CL, and the processor identifies the calibration line CL corresponding to the target bridge in the image to control the unmanned aerial vehicle 1 fly along the calibration line (i.e., fly from the calibration starting point SP to the calibration ending point EP). It shall be appreciated that the world coordinates of the calibration starting point SP and the calibration ending point EP of the calibration line CL are known (e.g., the longitude and latitude coordinates of the real world), these world coordinate refers to a value that can be interpreted by humans or software, such as longitude and latitude, bridge mileage, or coordinate values on map data.

In some embodiments, during the calibration stage CS, the unmanned aerial vehicle 1 can perform inspection tasks at the same time, which can reduce the cost of repeated flights of the unmanned aerial vehicle 1.

It shall be appreciated that, in the present disclosure, the unmanned aerial vehicle 1 can perform visual positioning and navigation through captured images. In some embodiments, the unmanned aerial vehicle 1 also comprises an optical flow module that looks down on the ground, so that the movement vector and the offset of the unmanned aerial vehicle 1 relative to the ground in a short period of time can be calculated based on the image captured by the optical flow module. Based on the optical flow positioning function, the unmanned aerial vehicle can hover in the air in a GPS-free environment, and can perform slight flight movements to the surrounding area.

In some embodiments, in order to make the judgment information more accurate, the calibration line CL is located at an image position corresponding to an area of about three-quarters of the target bridge TB of the image (i.e., the target bridge TB occupies three-quarters of the area and the surrounding area occupies one-quarter of the area).

In some embodiments, the processor can control the unmanned aerial vehicle 1 to fly close to the calibration line based on preset parameters to reduce errors caused by measurement. Specifically, the processor calculates an angle between the flight direction of the unmanned aerial vehicle 1 and the calibration line and a distance between the unmanned aerial vehicle 1 and the calibration line. Next, the processor adjusts the flight direction of the unmanned aerial vehicle 1 based on the angle and the distance, wherein the angle between the flight direction and the calibration line is not greater than a preset angle value, and the distance between the unmanned aerial vehicle 1 and the calibration line is not greater than a preset distance value.

For example, when the processor determines that the distance between the unmanned aerial vehicle 1 and the calibration line is greater than the preset distance value, the processor controls the unmanned aerial vehicle 1 to perform a in-plane moving operation. In addition, when the processor determines that the angle between the flight direction of the unmanned aerial vehicle 1 and the calibration line is greater than the preset angle value, the processor controls the unmanned aerial vehicle 1 to perform a turning operation.

For ease of understanding, please continue to refer to FIG. 2. FIG. 2 illustrates an image schematic diagram 201 captured by the unmanned aerial vehicle 1, which comprises a target area TA and a calibration line CL. First, a virtual reference line RL is defined in the vertical direction of the image, the reference line RL is configured to fit the calibration line CL on the image to ensure that the unmanned aerial vehicle 1 flies along the line (i.e., the reference line RL for the flight of the unmanned aerial vehicle 1 should be as close as possible to the calibration line CL).

In the present example, the vertical line VL from the center point CP of the reference line RL to the calibration line CL is calculated, and the distance (unit: pixel) between the reference line RL and the calibration line CL can be known from the length of the vertical line VL. The angle AG between the reference line RL and the calibration line CL can be known from the slopes of the two. Based on the distance and angle AG, the flight direction FD and relative position of the unmanned aerial vehicle 1 can be adjusted to minimize the distance and angle AG to ensure that the unmanned aerial vehicle 1 can fly along the calibration line CL.

It shall be appreciated that since the calibration line CL is still located where the GPS signal can be received (i.e., the GPS signal is not completely blocked), the unmanned aerial vehicle 1 can fly to the calibration starting point SP of the calibration line CL through GPS positioning, image recognition, etc., and obtain the image schematic diagram 201 as shown in FIG. 2 at any time point.

Next, in the present embodiment, the processor records an actual flight path of the unmanned aerial vehicle 1 to construct a virtual map (for example: operation S704 in FIG. 7).

In some embodiments, the present disclosure is based on performing a visual simultaneous localization and mapping (SLAM) operation to generate the virtual map, and the virtual map is composed of a plurality of point clouds corresponding to a plurality of locations.

For example, the processor can extract a set of image features (e.g., edges or corners) from the input image, compare the image features captured by the upward camera device at a similar time, and minimize reprojection errors of the features. Through SLAM operation, the image captured by the upward camera device can be correspondingly calculated to the coordinate value of the virtual coordinate system, which represents the position of the upward camera device (or the unmanned aerial vehicle 1) in the virtual space.

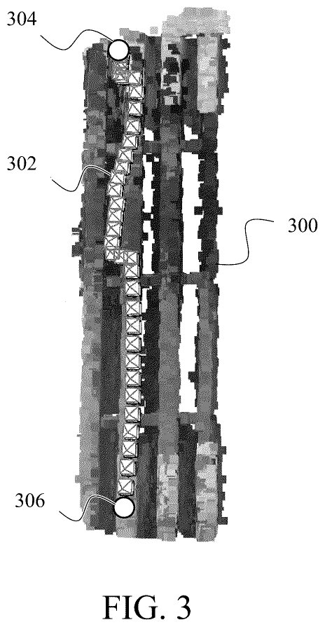

For example, please refer to FIG. 3, which shows an output schematic diagram of a visual SLAM, which comprises a constructed feature map 300 and the coordinate sequence 302 of an upward camera device (or the unmanned aerial vehicle 1). The feature map 300 is composed of point clouds, which can present the three-dimensional appearance of the photographed object, and any point in the coordinate sequence 302 has a corresponding time stamp and coordinate value of the virtual coordinate system (i.e., the map-building coordinate system), which can be used to refer to the corresponding photographed image frame. In summary, through the starting point 304 and the ending point 306 of the coordinate sequence 302 of the camera, the coordinate values of the starting point and the ending point of the calibration line in the virtual coordinate system can be known.

In addition, after the unmanned aerial vehicle 1 completes the calibration flight, the unmanned aerial vehicle 1 can store the SLAM calculation model as a base map (i.e., a virtual map), where the base map at least comprises: camera parameters, feature maps, coordinate sequence and corresponding time stamp, and the basic map will be used for positioning of the inspection stage IS.

In some embodiments, the virtual map records at least one of a camera parameter, a feature map, a coordinate sequence, a time stamp, or a combination thereof corresponding to each of a plurality of locations.

Finally, in the present embodiment, the processor calculates a coordinate transformation matrix corresponding to the virtual map and the real world based on the actual flight path and the calibration line CL (e.g., operation S705 in FIG. 7).

It shall be appreciated that the actual flight path corresponds to a virtual coordinate system, the calibration line CL corresponds to a world coordinate system, and the coordinate transformation matrix is configured to transform the virtual coordinate system to the world coordinate system.

Specifically, the coordinate transformation matrix comprises an alignment operation of a coordinate system orientation and a coordinate system scale.

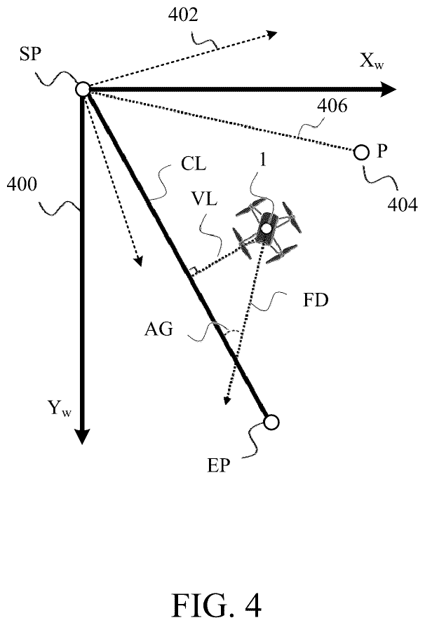

For ease of understanding, please refer to FIG. 4. FIG. 4 is a schematic diagram of the relationship between the world coordinate system 400 and the virtual coordinate system 402, which comprises the calibration starting point SP and the calibration ending point EP of the calibration line CL. The vertical line VL can be calculated from the position of the unmanned aerial vehicle 1 and the calibration line CL, which is regarded as the distance from the calibration line CL. The angle AG can be calculated between the flight direction FD of the unmanned aerial vehicle 1 and the calibration line CL.

In the present example

$$( {x}_{w}^{0} , {y}_{w}^{0} )$$

is set as the coordinate value of the calibration starting point SP of the calibration line CL in the world coordinate system 400, and the coordinate values of a point P 404 in the space in the world coordinate system 400 and the virtual coordinate system 402 are (x_{w}, y_{w}) and (xₛ, yₛ) respectively, the two can be transformed to each other through a rotation scaling matrix A_{2×2} (i.e., the coordinate transformation matrix A).

For example, the processor can calculate the coordinate transformation matrix A using the following equation:

$$[ \begin{matrix}{x}_{w} \\ {y}_{w}\end{matrix} ] = A \cdot [ \begin{matrix}{x}_{s} \\ {y}_{s}\end{matrix} ] + [ \begin{matrix}{x}_{w}^{0} \\ {y}_{w}^{0}\end{matrix} ]$$

In some embodiments, the processor can calculate an inverse matrix through the coordinate transformation matrix A to transform the coordinates/path represented by the world coordinate system into coordinates/path represented by the virtual coordinate system.

For example, the processor can calculate the inverse coordinate transformation matrix A⁻¹ using the following equation:

$$[ \begin{matrix}{x}_{s} \\ {y}_{s}\end{matrix} ] = {A}^{- 1} \cdot [ \begin{matrix}{x}_{w} - {x}_{w}^{0} \\ {y}_{w} - {y}_{w}^{0}\end{matrix} ]$$

It shall be appreciated that since the coordinate values of the calibration starting point SP and the calibration ending point EP of the calibration line CL in the world coordinate system 400 and the virtual coordinate system 402 are known respectively, the above coordinate transformation matrix A can be obtained through singular value decomposition.

Next, in the present disclosure, the specific operation of the unmanned aerial vehicle 1 in the inspection stage IS will be described below.

After completing the calibration stage CS, the virtual map and the coordinate transformation matrix A can be obtained. The unmanned aerial vehicle 1 first loads the virtual map during the inspection stage IS (e.g., operation S706 in FIG. 7) to continue the previously constructed SLAM mapping coordinates. Next, using the same method as in the calibration stage CS, the processor controls the unmanned aerial vehicle 1 to fly to the calibration starting point SP of the calibration line CL to continue map construction (e.g., perform a visual SLAM operation). The unmanned aerial vehicle 1 can calculate the origin of the virtual coordinate system where the calibration starting point SP of the calibration line CL is located based on the virtual map (e.g., operation S707 in FIG. 7).

In addition, during the actual inspection, the unmanned aerial vehicle 1 can perform a predetermined route task, and during the flight, the map construction can be continued and the coordinates of the upward camera device (or the unmanned aerial vehicle 1) of the virtual coordinate system can be obtained. Through the aforementioned transformation operation, the photographic data can be transformed from the virtual coordinate system to the world coordinate system to complete the data positioning process.

Specifically, the processor controls the unmanned aerial vehicle 1 to fly along the virtual inspection paths based on a plurality of virtual inspection paths and the virtual map. Then, the processor records the actual flight path of the unmanned aerial vehicle 1 to continuously constructing the virtual map. Finally, the processor positions the unmanned aerial vehicle 1 based on the coordinate transformation matrix to generate a plurality of inspection images corresponding to the target bridge and a real coordinate value of the real world corresponding to each of the inspection images.

It shall be appreciated that the inspection path comprises a plurality of checkpoints, and the checkpoints in the present disclosure are the locations where the target object (i.e., the target bridge) needs to be inspected. Taking the example of bridge inspection as an example, these checkpoints are important locations for inspecting the safety structure of the bridge (i.e., unmanned aerial vehicles are required to take images of the target to be inspected from the checkpoints), and these important locations need to be transformed to world coordinates for accurate interpretation.

In addition, in the inspection task mode, the unmanned aerial vehicle 1 can first transform a series of waypoints (such as checkpoints) in the world coordinates to the virtual coordinate system through the aforementioned transformation operation. As shown in FIG. 4, the starting point of this task is the origin of the virtual coordinate system (i.e., the calibration starting point SP). Given a task waypoint P 404, a virtual route 406 can be formed, and the relative position and flight direction FD of the unmanned aerial vehicle 1 can be adjusted to minimize the relative distance and relative angle between the flight direction FD of the unmanned aerial vehicle 1 and the virtual route 406 (for example: operation S708 in FIG. 7) until the target waypoint P 404 is reached. By repeating the above procedure, the flight tasks for each waypoint can be completed in sequence. During the flight, map construction can be continued and the coordinates of the upward camera device of the virtual coordinate system can be obtained. Through the aforementioned transformation operation, the photographic data can be transformed from the virtual coordinate system to the world coordinate system and complete the data positioning process (for example: operation S709 in FIG. 7).

In some embodiments, the processor generates a coordinate transformation inverse matrix corresponding to the coordinate transformation matrix A based on the coordinate transformation matrix A. Next, the processor transforms a plurality of inspection paths corresponding to the real world based on the coordinate transformation inverse matrix to generate the virtual inspection paths.

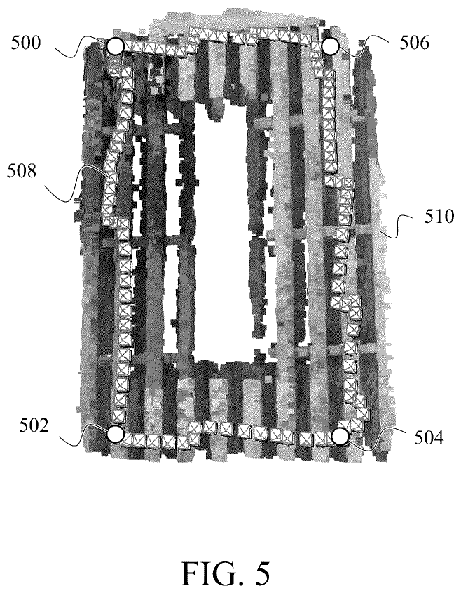

In addition, FIG. 5 illustrates the schematic diagram of the inspection task flight results using the basic model in FIG. 3, in which four sets of waypoints 500, 502, 504, and 506 are preset. Flying through the above-mentioned route task mode can generate a series of flight paths 508 for the unmanned aerial vehicle, and simultaneously execute SLAM to construct a virtual map 510 to assist continuous positioning and navigation.

In some embodiments, the checkpoints (or inspection paths) corresponding to the target to be inspected may be generated by a processor based on a plurality of inspection rules (e.g., checkpoints need to be set every 5 meters away), or may be preset by professionals.

It shall be appreciated that the checkpoint in the present disclosure can also be called a waypoint, which can comprise information such as longitude, latitude, altitude, drone head direction, camera angle (i.e., the angle from which the unmanned aerial vehicle shoots at the waypoint), etc.

In the present embodiment, the processor can perform the inspection operation through the visual navigation of the unmanned aerial vehicle 1 based on the coordinate transformation matrix and virtual map generated in the calibration stage CS in the absence of a GPS signal (i.e., under the target bridge).

As can be seen from the above description, the unmanned aerial vehicle 1 provided by the present disclosure constructs a virtual map by identifying the calibration line of the target bridge with known position information and the actual flight path of the unmanned aerial vehicle. Then, the unmanned aerial vehicle 1 provided by the present disclosure calculates the coordinate transformation matrix corresponding to the virtual map and the real world based on the actual flight path and the calibration line. In addition, the unmanned aerial vehicle 1 provided by the present disclosure can further control the unmanned aerial vehicle to fly along, based on a plurality of virtual inspection paths and the virtual map, the virtual inspection paths to detect the target bridge, and generate a plurality of inspection images corresponding to the target bridge and the real coordinate value of the real world corresponding to each of the inspection images. Due to the unmanned aerial vehicle 1 provided by the present disclosure, the task of inspecting bridges can be automatically and efficiently performed, thereby solving the shortcomings of the conventional technology.

Next, the specific operation of the second embodiment will be described in detail below. In short, in addition to the operations performed in the first embodiment, in the second embodiment, the upward camera device captures an image corresponding to the target bridge including an obscured part corresponding to a Global Positioning System (i.e., no GPS signal) and an unobstructed part (i.e., with GPS signal) (e.g., the operation S701 in FIG. 7).

For example, as shown in FIG. 1, the left half of the image schematic diagram 100 is the area where the GPS signal cannot be received (i.e., the area under the target bridge area is the part where the GPS signal is blocked), and the right half of the schematic image 100 is the area where the GPS signal can be received (i.e., the unobstructed part of the GPS signal).

Since the unmanned aerial vehicle 1 is located at the junction of the areas that can receive GPS signals, it can operate through the first embodiment and use the processor to control to the unmanned aerial vehicle 1 to fly along the calibration line (i.e. from calibration starting point to calibration ending point) based on the image comprising a bridge bottom part and a sky part to perform the operations of the calibration stage CS. In addition, the processor performs the operation of the inspection stage IS based on the coordinate transformation matrix and virtual map generated at the calibration stage CS.

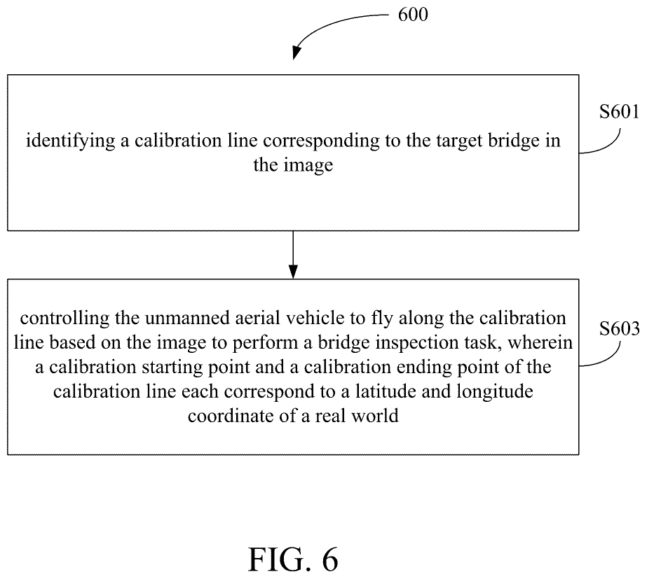

A third embodiment of the present disclosure is a bridge inspection method and a flowchart thereof is depicted in FIG. 6. The bridge inspection method 600 is adapted for an unmanned aerial vehicle (e.g., the unmanned aerial vehicle 1 of the first embodiment). The unmanned aerial vehicle comprises an upward camera device and a processor (e.g., the upward camera device and the processor of the first embodiment). The upward camera device is configured to capture an image corresponding to a target bridge based on an upward shooting angle (e.g., the operation S701 in FIG. 7). The bridge inspection method 600 calculates a coordinate transformation matrix corresponding to the virtual map and the real world through steps S601 to S603.

In the step S601, the unmanned aerial vehicle identifies a calibration line corresponding to the target bridge in the image (e.g., the operation S702 in FIG. 7).

Next, in the step S603, the unmanned aerial vehicle controls the unmanned aerial vehicle to fly along the calibration line based on the image to perform a bridge inspection task (e.g., the operation S703 in FIG. 7), wherein a calibration starting point and a calibration ending point of the calibration line each correspond to a latitude and longitude coordinate of a real world.

In some embodiments, the bridge inspection method 600 further comprises the following steps: recording an actual flight path of the unmanned aerial vehicle to construct a virtual map (e.g., the operation S704 in FIG. 7); and calculating a coordinate transformation matrix corresponding to the virtual map and the real world based on the actual flight path and the calibration line (e.g., the operation S705 in FIG. 7).

In some embodiments, the bridge inspection method 600 further comprises the following steps: controlling, based on a plurality of virtual inspection paths and the virtual map, the unmanned aerial vehicle to fly along the virtual inspection paths; recording the actual flight path of the unmanned aerial vehicle to continuously construct the virtual map; and positioning the unmanned aerial vehicle based on the coordinate transformation matrix to generate a plurality of inspection images corresponding to the target bridge and a real coordinate value of the real world corresponding to each of the inspection images.

In some embodiments, the virtual inspection paths are generated based on the following steps: generating a coordinate transformation inverse matrix corresponding to the coordinate transformation matrix based on the coordinate transformation matrix; and transforming a plurality of inspection paths corresponding to the real world based on the coordinate transformation inverse matrix to generate the virtual inspection paths.

In some embodiments, the step of controlling the unmanned aerial vehicle to fly along the calibration line comprises the following steps: calculating an angle between the flight direction of the unmanned aerial vehicle and the calibration line and a distance between the unmanned aerial vehicle and the calibration line; and adjusting the flight direction of the unmanned aerial vehicle based on the angle and the distance, wherein the angle between the flight direction and the calibration line is not greater than a preset angle value, and the distance between the unmanned aerial vehicle and the calibration line is not greater than a preset distance value.

In addition to the aforesaid steps, the third embodiment can also execute all the operations and steps of the unmanned aerial vehicle 1 set forth in the first embodiment and the second embodiment, have the same functions, and deliver the same technical effects as the first embodiment and the second embodiment. How the third embodiment executes these operations and steps, has the same functions, and delivers the same technical effects will be readily appreciated by those of ordinary skill in the art based on the explanation of the first embodiment and the second embodiment. Therefore, the details will not be repeated herein.

According to the above descriptions, the bridge inspection technology (at least including the apparatus and the method) provided by the present disclosure constructs a virtual map by identifying the calibration line of the target bridge with known position information and the actual flight path of the unmanned aerial vehicle. Then, the bridge inspection technology provided by the present disclosure calculates the coordinate transformation matrix corresponding to the virtual map and the real world based on the actual flight path and the calibration line. In addition, the bridge inspection technology provided by the present disclosure can further control the unmanned aerial vehicle to fly along, based on a plurality of virtual inspection paths and the virtual map, the virtual inspection paths to detect the target bridge, and generate a plurality of inspection images corresponding to the target bridge and the real coordinate value of the real world corresponding to each of the inspection images. Due to the bridge inspection technology provided by the present disclosure, the task of inspecting bridges can be automatically and efficiently performed, thereby solving the shortcomings of the conventional technology.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An unmanned aerial vehicle for bridge inspection, comprising:
an upward camera device, being configured to capture an image corresponding to a target bridge based on an upward shooting angle, wherein the image comprises an obscured part and an unobstructed part corresponding to a global positioning system; and
a processor, being electrically connected to the upward camera device, and being configured to perform operations comprising:
identifying a calibration line corresponding to the target bridge in the image; and
controlling the unmanned aerial vehicle to fly along the calibration line based on the image comprising the obscured part and the unobstructed part to perform a bridge inspection task, wherein a calibration starting point and a calibration ending point of the calibration line each correspond to a latitude and longitude coordinate of a real world.

2. The unmanned aerial vehicle for bridge inspection of claim 1, wherein the operation of controlling the unmanned aerial vehicle to fly along the calibration line comprises the following operations:
calculating an angle between a flight direction of the unmanned aerial vehicle and the calibration line and a distance between the unmanned aerial vehicle and the calibration line; and
adjusting the flight direction of the unmanned aerial vehicle based on the angle and the distance, wherein the angle between the flight direction and the calibration line is not greater than a preset angle value, and the distance between the unmanned aerial vehicle and the calibration line is not greater than a preset distance value.

3. The unmanned aerial vehicle for bridge inspection of claim 1, wherein the processor is further configured to perform the following operations:
recording an actual flight path of the unmanned aerial vehicle to construct a virtual map; and
calculating a coordinate transformation matrix corresponding to the virtual map and the real world based on the actual flight path and the calibration line.

4. The unmanned aerial vehicle for bridge inspection of claim 3, wherein the actual flight path corresponds to a virtual coordinate system, the calibration line corresponds to a world coordinate system, and the coordinate transformation matrix is configured to transform the virtual coordinate system to the world coordinate system.

5. The unmanned aerial vehicle for bridge inspection of claim 3, wherein the coordinate transformation matrix comprises an alignment operation of a coordinate system orientation and a coordinate system scale.

6. The unmanned aerial vehicle for bridge inspection of claim 3, wherein the processor is further configured to perform the following operations:
controlling, based on a plurality of virtual inspection paths and the virtual map, the unmanned aerial vehicle to fly along the virtual inspection paths;
recording the actual flight path of the unmanned aerial vehicle to continuously construct the virtual map; and
positioning the unmanned aerial vehicle based on the coordinate transformation matrix to generate a plurality of inspection images corresponding to the target bridge and a real coordinate value of the real world corresponding to each of the inspection images.

7. The unmanned aerial vehicle for bridge inspection of claim 6, wherein the virtual inspection paths are generated based on the following operations:
generating a coordinate transformation inverse matrix corresponding to the coordinate transformation matrix based on the coordinate transformation matrix; and
transforming a plurality of inspection paths corresponding to the real world based on the coordinate transformation inverse matrix to generate the virtual inspection paths.

8. The unmanned aerial vehicle for bridge inspection of claim 3, wherein the virtual map is generated based on performing a visual simultaneous localization and mapping operation, and the virtual map is composed of a plurality of point clouds corresponding to a plurality of locations.

9. The unmanned aerial vehicle for bridge inspection of claim 3, wherein the virtual map records at least one of a camera parameter, a feature map, a coordinate sequence, a time stamp, or a combination thereof corresponding to each of a plurality of locations.

10. An unmanned aerial vehicle for bridge inspection, comprising:
an upward camera device, being configured to capture an image corresponding to a target bridge based on an upward shooting angle, wherein the image comprises a bridge bottom part and a sky part corresponding to the target bridge; and
a processor, being electrically connected to the upward camera device, and being configured to perform operations comprising:
identifying a calibration line corresponding to the target bridge in the image; and
controlling the unmanned aerial vehicle to fly along the calibration line based on the image comprising the bridge bottom part and the sky part to perform a bridge inspection task, wherein a calibration starting point and a calibration ending point of the calibration line each correspond to a latitude and longitude coordinate of a real world.

11. The unmanned aerial vehicle for bridge inspection of claim 10, wherein the operation of controlling the unmanned aerial vehicle to fly along the calibration line comprises the following operations:
calculating an angle between a flight direction of the unmanned aerial vehicle and the calibration line and a distance between the unmanned aerial vehicle and the calibration line; and
adjusting the flight direction of the unmanned aerial vehicle based on the angle and the distance, wherein the angle between the flight direction and the calibration line is not greater than a preset angle value, and the distance between the unmanned aerial vehicle and the calibration line is not greater than a preset distance value.

12. The unmanned aerial vehicle for bridge inspection of claim 10, wherein the processor is further configured to perform the following operations:
recording an actual flight path of the unmanned aerial vehicle to construct a virtual map; and
calculating a coordinate transformation matrix corresponding to the virtual map and the real world based on the actual flight path and the calibration line.

13. The unmanned aerial vehicle for bridge inspection of claim 12, wherein the actual flight path corresponds to a virtual coordinate system, the calibration line corresponds to a world coordinate system, and the coordinate transformation matrix is configured to transform the virtual coordinate system to the world coordinate system.

14. The unmanned aerial vehicle for bridge inspection of claim 12, wherein the coordinate transformation matrix comprises an alignment operation of a coordinate system orientation and a coordinate system scale.

15. The unmanned aerial vehicle for bridge inspection of claim 12, wherein the processor is further configured to perform the following operations:
controlling, based on a plurality of virtual inspection paths and the virtual map, the unmanned aerial vehicle to fly along the virtual inspection paths;
recording the actual flight path of the unmanned aerial vehicle to continuously construct the virtual map; and
positioning the unmanned aerial vehicle based on the coordinate transformation matrix to generate a plurality of inspection images corresponding to the target bridge and a real coordinate value of the real world corresponding to each of the inspection images.

16. The unmanned aerial vehicle for bridge inspection of claim 15, wherein the virtual inspection paths are generated based on the following operations:
generating a coordinate transformation inverse matrix corresponding to the coordinate transformation matrix based on the coordinate transformation matrix; and
transforming a plurality of inspection paths corresponding to the real world based on the coordinate transformation inverse matrix to generate the virtual inspection paths.

17. The unmanned aerial vehicle for bridge inspection of claim 12, wherein the virtual map is generated based on performing a visual simultaneous localization and mapping operation, and the virtual map is composed of a plurality of point clouds corresponding to a plurality of locations.

18. The unmanned aerial vehicle for bridge inspection of claim 12, wherein the virtual map records at least one of a camera parameter, a feature map, a coordinate sequence, a time stamp, or a combination thereof corresponding to each of a plurality of locations.

19. A bridge inspection method, being adapted for use in an unmanned aerial vehicle, wherein the unmanned aerial vehicle comprises an upward camera device and a processor, the upward camera device is configured to capture an image corresponding to a target bridge based on an upward shooting angle, and the bridge inspection method comprises the following steps:
identifying a calibration line corresponding to the target bridge in the image; and
controlling the unmanned aerial vehicle to fly along the calibration line based on the image to perform a bridge inspection task, wherein a calibration starting point and a calibration ending point of the calibration line each correspond to a latitude and longitude coordinate of a real world.

20. The bridge inspection method of claim 19, wherein the step of controlling the unmanned aerial vehicle to fly along the calibration line comprises the following steps:
calculating an angle between a flight direction of the unmanned aerial vehicle and the calibration line and a distance between the unmanned aerial vehicle and the calibration line; and
adjusting the flight direction of the unmanned aerial vehicle based on the angle and the distance, wherein the angle between the flight direction and the calibration line is not greater than a preset angle value, and the distance between the unmanned aerial vehicle and the calibration line is not greater than a preset distance value.
